(19) United States
(12) Patent Application Publication
(10) Pub. No.: US 2026/0329255 A1
(43) Pub. Date: Oct. 22, 2026

(54) ADDITIVE MANUFACTURING FOR VIBRATION DAMPING

(71) Applicant: International Business Machines Corporation, Armonk, NY (US)

(72) Inventors: Tiberiu SUTO, Franklin, NY (US); Michael BOONE, Lutz, FL (US); Sarbajit Kumar RAKSHIT, Kolkata (IN); Carolina GARCIA DELGADO, Zapopan (MX)

(21) Appl. No.: 19/181,778

(22) Filed: Apr. 17, 2025

(51) Int. Cl. G05B 19/4099

(52) U.S. Cl. CPC G05B 19/4099; G05B 2219/32335; G05B 2219/49023; G05B 2219/49048

(57) ABSTRACT

In some implementations, a device may receive vibration data associated with one or more target objects. The device may identify, using the vibration data, a vibration damping rate associated with the one or more target objects. The device may receive spatial data associated with the one or more target objects. The device may identify, using the spatial data, one or more candidate additive manufacturing vibration damping object locations. The device may generate, based on the vibration damping rate and the one or more candidate additive manufacturing vibration damping object locations, one or more candidate additive manufacturing vibration damping object models. The device may identify one or more predicted vibration damping rates associated with the one or more candidate additive manufacturing vibration damping object models.

### BACKGROUND

This disclosure relates to additive manufacturing, and more specifically, to additive manufacturing for vibration damping.

### SUMMARY

Some aspects described herein relate to a computer-implemented method. The method may include receiving, by a device, vibration data associated with one or more target objects. The method may include identifying, by the device, using the vibration data, a vibration damping rate associated with the one or more target objects. The method may include receiving, by the device, spatial data associated with the one or more target objects. The method may include identifying, by the device, using the spatial data, one or more candidate additive manufacturing vibration damping object locations. The method may include generating, by the device, based on the vibration damping rate and the one or more candidate additive manufacturing vibration damping object locations, one or more candidate additive manufacturing vibration damping object models. The method may include identifying, by the device, one or more predicted vibration damping rates associated with the one or more candidate additive manufacturing vibration damping object models.

Some aspects described herein relate to a computer system. The computer system may include a processor set, one or more computer-readable storage media, and program instructions stored on the one or more computer-readable storage media to cause the processor set to perform operations. The operations may include receiving vibration data associated with one or more target objects. The operations may include identifying, using the vibration data, a vibration damping rate associated with the one or more target objects. The operations may include receiving spatial data associated with the one or more target objects. The operations may include identifying, using the spatial data, one or more candidate additive manufacturing vibration damping object locations. The operations may include generating, based on the vibration damping rate and the one or more candidate additive manufacturing vibration damping object locations, one or more candidate additive manufacturing vibration damping object models using a generative adversarial network model. The operations may include identifying one or more predicted vibration damping rates associated with the one or more candidate additive manufacturing vibration damping object models.

Some aspects described herein relate to a computer program product. The computer program product may include one or more computer-readable storage media and program instructions stored on the one or more computer-readable storage media to perform operations. The operations may include receiving vibration data associated with one or more target objects. The operations may include identifying, using the vibration data, a vibration damping rate associated with the one or more target objects. The operations may include receiving spatial data associated with the one or more target objects. The operations may include identifying, using the spatial data, one or more candidate additive manufacturing vibration damping object locations. The operations may include generating, based on the vibration damping rate and the one or more candidate additive manufacturing vibration damping object locations, one or more candidate additive manufacturing vibration damping object models. The operations may include identifying one or more predicted vibration damping rates associated with the one or more candidate additive manufacturing vibration damping object models using a digital twin simulation.

### BRIEF DESCRIPTION OF THE DRAWINGS

FIG. 1 is a diagram of an example computing environment for additive manufacturing for vibration damping described herein.

FIGS. 2A-2C are diagrams of an example associated with additive manufacturing for vibration damping as described herein.

FIG. 3 is a diagram of example components of a device associated with additive manufacturing for vibration damping.

FIG. 4 is a flowchart of an example process associated with additive manufacturing for vibration damping.

### DETAILED DESCRIPTION

The following detailed description of example implementations refers to the accompanying drawings. The same reference numbers in different drawings may identify the same or similar elements.

Additive manufacturing (e.g., 3D printing) is a process by which a three-dimensional object is constructed using a digital 3D model (e.g., a computer-aided design (CAD) model). For example, 3D printing may involve depositing a layer of material and joining or solidifying the layer under computer control (e.g., the layer may include solidified plastics, solidified liquids, fused powder grains, or the like). This process may be repeated as additional material is added layer-by-layer, eventually resulting in a 3D-printed object.

Objects in industrial settings are susceptible to various forms of wear and tear, corrosion, and machine health issues, resulting in the generation of vibrations. Basic maintenance may be unable to sufficiently reduce vibrations, as a health status of an object can change over time due to progressive wear and tear. As a result, vibrations can cause structural damage, equipment malfunction, decreased productivity, and worker safety risks. Sufficiently damping the vibrations is often impractical because various inter-related factors (e.g., the type of vibration damping mechanism (e.g., a type of spring), where the vibration damping mechanism is integrated into the industrial setting, or the like) may impact the effectiveness of the vibration damping. For example, a trial-and-error approach of integrating vibration damping mechanisms into the industrial setting can consume memory and processing resources in electronic tools used to add, remove, and/or re-locate the vibration damping mechanism. Additionally, or alternatively, testing different vibration damping mechanisms (e.g., different types of springs) may increase memory and processing resources in electronic manufacturing tools that manufacture the different vibration damping mechanisms. As a result, determining the inter-related factors during or after integration of the vibration damping mechanism into the industrial setting can result in excessive or redundant consumption of memory or processing resources.

Some implementations described herein enable design and implementation of a vibration damping mechanism using 3D printing. The vibration damping mechanism may be designed based on data collected from an industrial setting, such as vibration data and spatial data. This data may enable a computer to determine various inter-related factors relating to vibration damping, such as specifications of the vibration damping mechanism (e.g., a type, size, and/or shape of the vibration damping mechanism), a location for the vibration damping mechanism in the industrial setting, or the like. For example, the computer may perform one or more simulations to determine a vibration damping effectiveness of a vibration damping mechanism under certain conditions (e.g., a particular specification of the vibration damping mechanism, a particular location of the vibration damping mechanism, or the like). In some examples, the computer may generate a digital 3D model of the vibration damping mechanism. For example, a 3D printer may use the digital 3D model to print the vibration damping mechanism on-site (e.g., directly on an object that is to be vibrationally damped).

As a result, the vibration damping mechanism may help to effectively damp vibrations in the industrial setting, thereby mitigating structural damage, reducing equipment malfunction, increasing productivity, and improving worker safety. Furthermore, determining the specifications of the vibration damping mechanism and the location for the vibration damping mechanism based on the collected data may help to avoid a trial-and-error approach involving multiple iterations of vibration damping mechanisms. Thus, consumption of memory and processing resources in electronic tools that would otherwise be used to repeatedly add, remove, and/or re-locate vibration damping mechanisms may be reduced. Additionally, or alternatively, consumption of memory and processing resources in electronic manufacturing tools that would otherwise manufacture different vibration damping mechanisms may be reduced. As a result, determining the inter-related factors before integration of the vibration damping mechanism into the industrial setting may reduce excessive or redundant consumption of memory or processing resources.

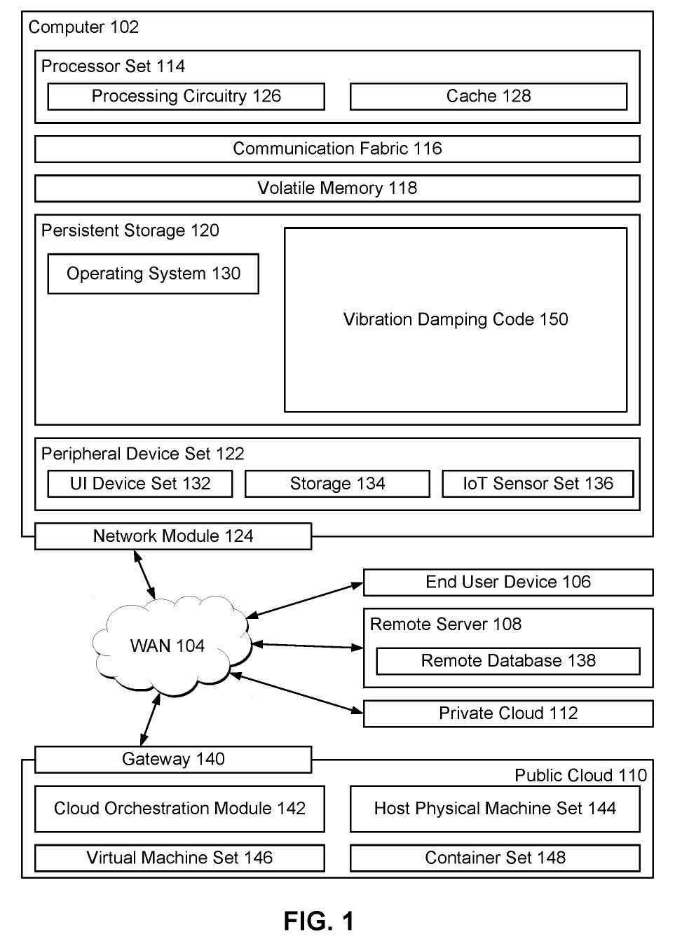

FIG. 1 is a diagram of an example computing environment 100 for additive manufacturing for vibration damping described herein.

The computing environment 100 contains an example of an environment for the execution of at least some of the computer code involved in performing the inventive methods, such as vibration damping code 150. In addition to the vibration damping code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the vibration damping code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in vibration damping code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the vibration damping code 150 typically includes at least some of the computer code involved in performing one or more operations described herein. In some implementations, the operations may include receiving vibration data associated with one or more target objects; identifying, using the vibration data, a vibration damping rate associated with the one or more target objects; receiving spatial data associated with the one or more target objects; identifying, using the spatial data, one or more candidate additive manufacturing vibration damping object locations; generating, based on the vibration damping rate and the one or more candidate additive manufacturing vibration damping object locations, one or more candidate additive manufacturing vibration damping object models; and identifying one or more predicted vibration damping rates associated with the one or more candidate additive manufacturing vibration damping object models.

In some implementations, the operations may include receiving vibration data associated with one or more target objects; identifying, using the vibration data, a vibration damping rate associated with the one or more target objects; receiving spatial data associated with the one or more target objects; identifying, using the spatial data, one or more candidate additive manufacturing vibration damping object locations; generating, based on the vibration damping rate and the one or more candidate additive manufacturing vibration damping object locations, one or more candidate additive manufacturing vibration damping object models using a generative adversarial network model; and identifying one or more predicted vibration damping rates associated with the one or more candidate additive manufacturing vibration damping object models.

In some implementations, the operations may include receiving vibration data associated with one or more target objects; identifying, using the vibration data, a vibration damping rate associated with the one or more target objects; receive spatial data associated with the one or more target objects; identifying, using the spatial data, one or more candidate additive manufacturing vibration damping object locations; generating, based on the vibration damping rate and the one or more candidate additive manufacturing vibration damping object locations, one or more candidate additive manufacturing vibration damping object models; and identifying one or more predicted vibration damping rates associated with the one or more candidate additive manufacturing vibration damping object models using a digital twin simulation.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

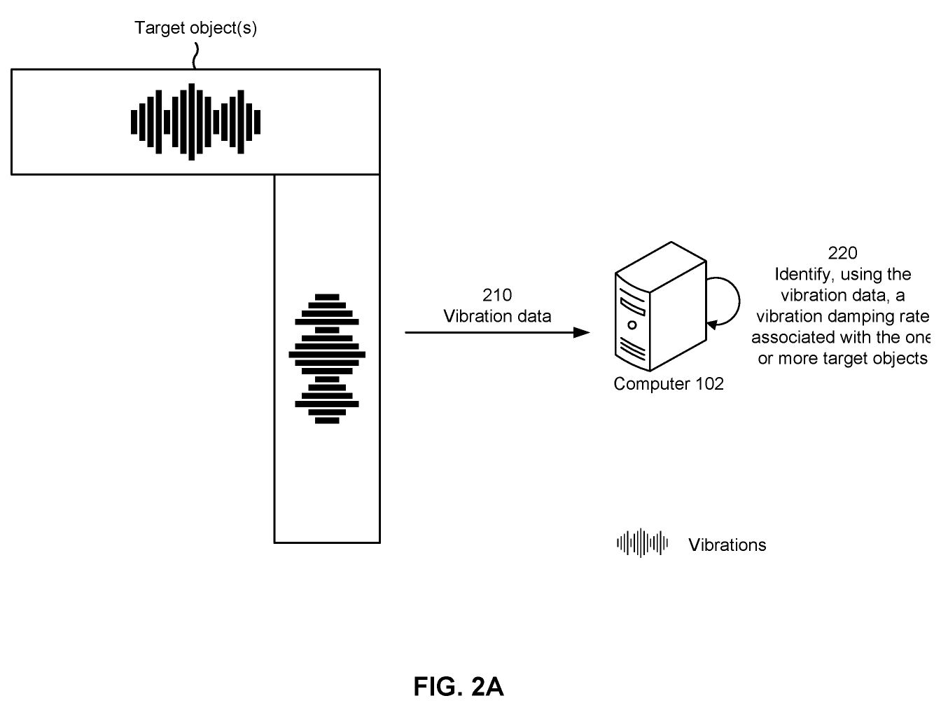

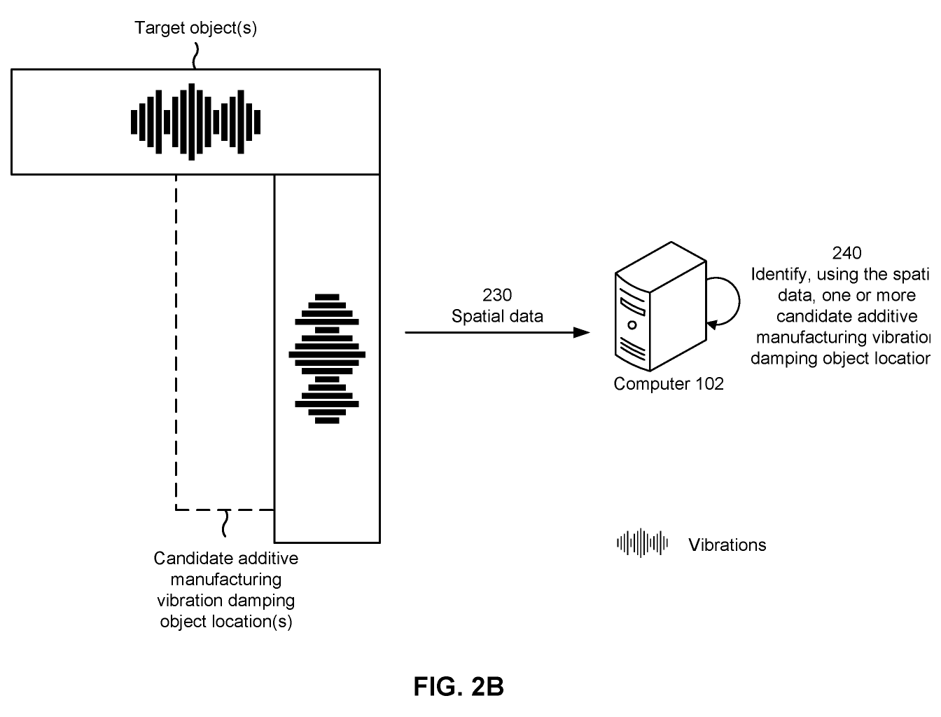

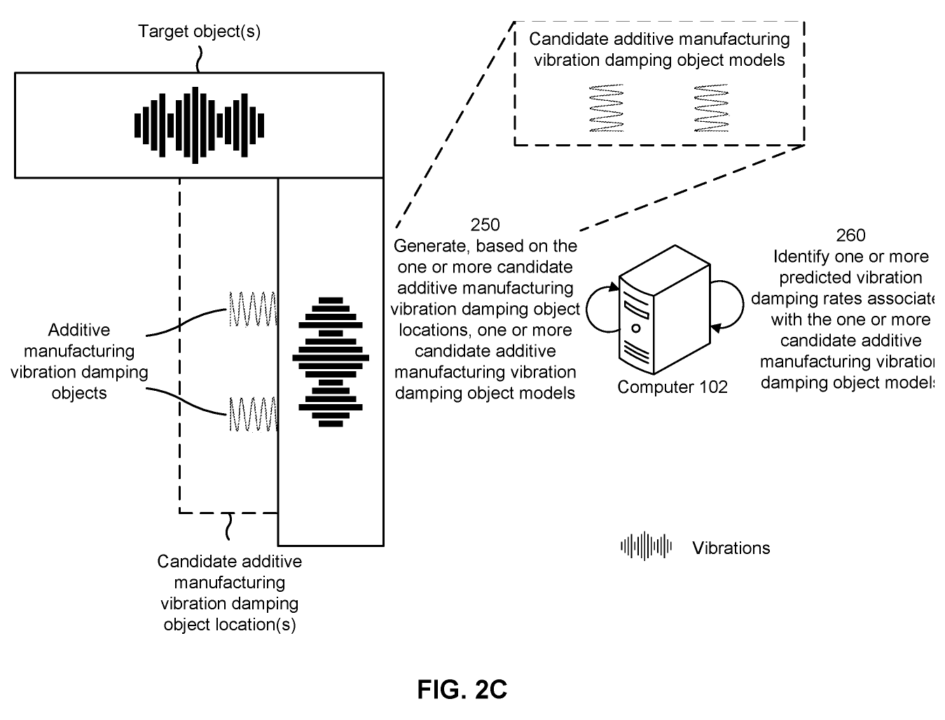

FIGS. 2A-2C are diagrams of an example 200 associated with additive manufacturing for vibration damping as described herein.

Example 200 includes one or more target objects and the computer 102. The target object(s) may be any physical object(s) susceptible to vibrations (e.g., vibrations that can damage the target object(s) and/or a surrounding environment of the target object(s)). For example, the vibrations may propagate through the target object(s). In some examples, the target object(s) may include one or more industrial objects, such as machines, structures, or the like. For example, the target object(s) shown in example 200 may be pipes. In some examples, the computer 102 may be communicatively coupled to an additive manufacturing apparatus (e.g., a 3D printer). For example, the computer 102 may communicate with the additive manufacturing apparatus over wired and/or wireless communication links using the communication fabric 116, the network module 124, or the like. The computer 102 may control various aspects of the operation of the additive manufacturing apparatus, such as additive manufacturing of an object. In some examples, the computer 102 may be a part of the additive manufacturing apparatus, and may correspond to the control system of the additive manufacturing apparatus (e.g., the computer 102 may be embedded in the form factor of the additive manufacturing apparatus). In some examples, the computer 102 may be located remotely from the additive manufacturing apparatus.

With reference to FIG. 2A, as shown by reference number 210, the computer 102 may receive vibration data associated with the one or more target objects. The vibration data may include information regarding detected vibrations, such as an amplitude of the vibrations, a frequency of the vibrations, a pattern of the vibrations (e.g., a periodicity of the vibrations), or the like. The vibration data may be associated with the one or more target objects in that the vibration data may include information regarding detected vibrations in or near the target object(s). For example, the vibration data may capture vibrations that are propagating toward, through, and/or from the target object(s). For example, in an industrial setting, the vibrations may originate from outside the target object(s) (e.g., due to construction or other environmental factors) or within the target object(s) (e.g., due to water flowing through pipes). Thus, the vibration data may indicate how the vibrations are propagating in or around the target object(s). In some examples, the vibration data may be collected by one or more sensors, such as internet of things (IoT) sensors, accelerometers, piezoelectric sensors, or other vibration sensors. The sensor(s) may be located on or in the target object(s) (e.g., the one or more sensors may detect vibrations propagating through the target object(s)), or in a vicinity of the target object(s) (e.g., the one or more sensors may detect vibrations that propagate to or from the target object(s)). Additionally, or alternatively, the computer 102 may receive other types of data associated with the one or more target objects, such as thermal data, force data, material data, or the like. For example, the computer 102 may receive the other types of data from one or more thermal sensors, force sensors, material sensors, pressure sensors, or the like. For example, the thermal sensors may be configured to measure a temperature of the target object(s) and/or an environment of the target object(s). Additionally, or alternatively, the force sensors may be configured to measure a force applied to the target object(s) and/or an object in the vicinity of the target object(s). Additionally, or alternatively, the material sensors may be configured to detect a material, or one or more material properties, of the target object(s) and/or an object in the vicinity of the target object(s) (e.g., the material sensors may be configured to detect the material properties of a substance from which the vibration is generated and/or through which the vibration is propagating). Additionally, or alternatively, the force sensors may be configured to measure a force applied to the target object(s) and/or an object in the vicinity of the target object(s). In some examples, the computer 102 may continuously monitor one or more data feeds that include the vibration data and/or other types of data. For example, the computer 102 may collect the vibration data and/or other types of data in real-time. Additionally, or alternatively, the computer 102 may collect the vibration data and/or other types of data at regular intervals, or upon transmitting a request for the vibration data and/or other types of data.

As shown by reference number 220, the computer 102 may identify, using the vibration data, a vibration damping rate associated with the one or more target objects. A vibration damping rate may be a measure of how rapidly a vibration decays over time. For example, the vibration damping rate may be indicated by a damping ratio, a damping coefficient, or the like. The vibration damping rate may be associated with the one or more target objects in that the vibration damping rate may be a measure of how rapidly a detected vibration in the one or more target objects or in a vibration propagation path of the one or more target object(s) decays over time. In some examples, the computer 102 may identify the vibration damping rate by evaluating the vibration data. For example, the computer 102 may identify how vibrations generated and/or propagated by the one or more target objects behave over time (e.g., how rapidly the vibrations decay). In some examples, the computer 102 may identify, from the vibration data, multi-source vibrations and calculate resulting vibration(s) propagating through the target object(s).

With reference to FIG. 2B, as shown by reference number 230, the computer 102 may receive spatial data associated with the one or more target objects. The spatial data may include geometric, location, and/or orientation information (e.g., volumetric, 3D information), or information indicating a physical relationship (e.g., a distance) between two or more objects. The spatial data may be associated with the one or more target objects in that the spatial data may include geometric, location, and/or orientation information of the target objects, and/or the spatial data may include information regarding a physical relationship (e.g., a distance) between the one or more target objects and one or more other nearby objects. In some examples, the spatial data may be via a visual scan of an area (e.g., an environment) in which the vibrations propagate (e.g., the area may include the target object(s)). In some examples, the visual scan may be carried out using a camera, a light detection and ranging (LiDAR) detector, or the like. In some examples, the computer 102 may, based on a scale of the area, select one or more parameters of the visual scan, such as a scanning resolution, a type of detector (e.g., a camera or a LiDAR detector), or the like. For example, the computer 102 may adjust the scanning parameters in real-time, which may enable the spatial data to convey detailed information regarding the area. The detector(s) may be integrated with, or separate from, the computer 102.

As shown by reference number 240, the computer 102 may identify, using the spatial data, one or more candidate additive manufacturing vibration damping object locations. A candidate additive manufacturing vibration damping object location is an available site where an additive manufacturing vibration damping object may be placed and/or additively manufactured (e.g., 3D-printed). For instance, as shown in example 200, the candidate additive manufacturing vibration damping object location may be adjacent to the target object(s). In some examples, the computer 102 may identify the one or more candidate additive manufacturing vibration damping object locations by creating a 3D model of the area using the spatial data. For example, the computer 102 may generate a point cloud representing the area (e.g., a 3D space or geometry of the area). In some examples, the computer 102 may convert the 3D space to a mesh model and use one or more convolutional neural networks (CNNs) to process volumetric data corresponding to the mesh model and analyze the area. For example, the CNNs may identify various clearances, gaps, and/or spaces that can be used as the one or more candidate additive manufacturing vibration damping object locations. Additionally, or alternatively, the computer 102 may identify the one or more candidate additive manufacturing vibration damping object locations using the vibration data (e.g., in response to determining that the vibration damping rate is insufficient to prevent damage to the target object(s)). For example, the computer 102 may determine that the vibration damping rate permits vibrations in the target object(s) that may damage the target object(s) within a given amount of time.

In some aspects, the computer 102 may identify the one or more candidate additive manufacturing vibration damping object locations based on one or more of a vibration source or a vibration propagation path associated with the one or more target objects. The vibration source may be associated with the one or more target objects in that the vibration source may generate the vibration experienced by the target object(s). In some examples, the target object(s) may be the vibration source. The vibration propagation path may be associated with the one or more target objects in that the target objects may be in the vibration propagation path (e.g., the vibrations may propagate toward and/or from the one or more target object(s)), or the vibration propagation path may spread from the target object(s). In some examples, the computer 102 may identify the vibration source or the vibration propagation path based on the vibration data and/or the spatial data. For example, the computer 102 may identify the vibration source or the vibration propagation path (and, thus, the one or more candidate additive manufacturing vibration damping object locations, based on the 3D model of the area.

With reference to FIG. 2C, as shown by reference number 250, the computer 102 may generate, based on the vibration damping rate and the one or more candidate additive manufacturing vibration damping object locations, one or more candidate additive manufacturing vibration damping object models. The one or more candidate additive manufacturing vibration damping object models may be one or more digital representations (e.g., one or more computer-aided design (CAD) models) of one or more candidate additive manufacturing vibration damping objects. The one or more candidate additive manufacturing vibration damping object models may be one or more 3D models. In some examples, the computer 102 may identify multiple candidate additive manufacturing vibration damping object models corresponding to respective candidate additive manufacturing vibration damping object locations. In some examples, the computer 102 may select the one or more candidate additive manufacturing vibration damping object models based on a target level of vibration damping identified based on the magnitude of the detected vibrations. For example, the computer 102 may identify the target level of vibration damping that is to be applied to the target object(s) (e.g., to the vibration source or the vibration propagation path). In some examples, the computer 102 may generate the candidate additive manufacturing vibration damping object model based on determining that the one or more modeled candidate additive manufacturing vibration damping objects can be accommodated within the one or more candidate additive manufacturing vibration damping object locations. “Vibration damping object” refers to an object configured to reduce or dissipate energy associated with mechanical vibrations in a system. In some examples, a vibration damping object may be a spring, such as coil springs, leaf springs, torsion springs, wave springs, or the like. A coil spring is a helical spring made of metal wire. Coil springs may offer high flexibility and vibration absorption capabilities, and, thus, may be used in various applications. Leaf springs include multiple layers of metal strips stacked together, and may be used in vehicles and other machinery to dampen vibrations. Torsion springs store mechanical energy in a twisted state. Torsion springs may be used to provide rotational or angular movement, or vibrational damping in certain applications. Wave springs are compact coil springs having wavy or corrugated shapes. A wave spring may provide large forces in small spaces, and may be used for vibrational damping in precision equipment.

In some aspects, the computer 102 may identify one or more additive manufacturing materials associated with the one or more candidate additive manufacturing vibration damping object models. An additive manufacturing material may be a material (e.g., filament) that can be used to additively manufacture (e.g., 3D print) an additive manufacturing object. Thus, the additive manufacturing object may be constructed, layer-by-layer, from the additive manufacturing material. The one or more additive manufacturing materials may be associated with the one or more candidate additive manufacturing vibration damping object models in that the one or more candidate additive manufacturing vibration damping object models may be one or more models of one or more additive manufacturing vibration damping objects that are to be constructed from the one or more additive manufacturing materials. In some examples, the computer 102 may select or determine the one or more additive manufacturing materials based on one or more vibration damping capabilities of the one or more additive manufacturing vibration damping objects constructed from the one or more additive manufacturing materials.

In some aspects, the computer 102 may generate the one or more candidate additive manufacturing vibration damping object models using a generative adversarial network (GAN) model. A GAN is a machine learning framework in which a GAN model (e.g., a generator) is trained to produce data based on output from a discriminator that attempts to distinguish generator-produced data from real data. For example, the GAN model may learn how to design one or more candidate additive manufacturing vibration damping objects based on historical designs and/or corresponding performances of those designs. During a deployment phase of the GAN model, the computer 102 may input, into the GAN model, the vibration data, the spatial data, and/or information derived therefrom (e.g., an indication of the vibration damping rate, an indication of the one or more candidate additive manufacturing vibration damping object locations, or the like). The GAN model may output, and the computer 102 may receive, the one or more candidate additive manufacturing vibration damping object models. The one or more candidate additive manufacturing vibration damping object models output by the GAN model may provide the target level of vibration damping and be accommodated within the one or more candidate additive manufacturing vibration damping object locations. In some examples, the GAN model may identify multiple candidate additive manufacturing vibration damping object models corresponding to respective candidate additive manufacturing vibration damping object locations.

In some aspects, the computer 102 may generate the one or more candidate additive manufacturing vibration damping object models based on one or more operational or environmental factors. The one or more operational factors may include conditions of a target use of the additive manufacturing vibration damping object (e.g., a target load to be supported by the additive manufacturing vibration damping object, an anticipated range of forces to be applied to the additive manufacturing vibration damping object). The one or more environmental factors may include one or more conditions of a target environment of the one or more candidate additive manufacturing vibration damping objects (e.g., the target environment may be one or more environments of the one or more candidate additive manufacturing vibration damping object locations). For example, the one or more environmental factors may include an expected temperature, an expected corrosion, or the like. In some examples, the one or more environmental factors may be indicated by the other types of data discussed above in connection with FIG. 2A. In some examples, the computer 102 may generate the one or more candidate additive manufacturing vibration damping object models based on one or more expected lifespans associated with the one or more candidate additive manufacturing vibration damping object models. For example, the computer 102 may determine the one or more expected lifespans based on the one or more operational or environmental factors. In some examples, the computer 102 may determine whether or not to add reinforcement to the one or more candidate additive manufacturing vibration damping object models. For example, the computer 102 may add reinforcements to one or more vulnerable portions of the one or more candidate additive manufacturing vibration damping object models.

In some aspects, the computer 102 may generate the one or more candidate additive manufacturing vibration damping object models based on an accessibility of an additive manufacturing apparatus. The additive manufacturing apparatus may be a 3D printer configured to create the one or more additive manufacturing vibration damping objects. In some examples, the accessibility may be associated with the one or more candidate additive manufacturing vibration damping object locations. The accessibility being associated with the one or more candidate additive manufacturing vibration damping object locations may refer to an ability of the additive manufacturing apparatus to print the one or more candidate additive manufacturing vibration damping object models in the one or more candidate additive manufacturing vibration damping object locations. For example, the computer 102 may determine whether the additive manufacturing apparatus can access the one or more candidate additive manufacturing vibration damping object locations to print the one or more additive manufacturing vibration damping objects. For example, if a nozzle of the additive manufacturing apparatus cannot reach the one or more candidate additive manufacturing vibration damping object locations (e.g., due to insufficient space near the one or more candidate additive manufacturing vibration damping object locations), then the one or more candidate additive manufacturing vibration damping object locations may be inaccessible to the additive manufacturing apparatus. In some examples, the computer 102 may determine the accessibility of the additive manufacturing apparatus to the one or more candidate additive manufacturing vibration damping object locations by analyzing the area of the target object(s), one or more properties of the one or more candidate additive manufacturing vibration damping object models (such as the shapes, sizes, and/or positions relative to the target object(s) or other nearby objects), one or more properties of the additive manufacturing apparatus (such as the shape, size and/or position near the one or more candidate additive manufacturing vibration damping object locations).

In some aspects, the computer 102 may generate the one or more candidate additive manufacturing vibration damping object models based on a vibration parameter associated with the one or more target objects satisfying a vibration parameter threshold. The vibration parameter may indicate a property of the vibrations experienced by the target object(s), such as magnitude, whether a target object is generating the vibrations or propagating the vibrations, or the like. The vibration parameter threshold may be an upper or lower limit of the vibration parameter beyond which the computer 102 may generate the one or more candidate additive manufacturing vibration damping object models. For example, the vibration parameter threshold may represent a baseline vibration level under typical operating conditions. In some examples, the computer 102 may determine whether or not the vibration parameter (e.g., the generated or propagated vibration) exceeds the vibration parameter threshold. For example, if the computer 102 determines that the magnitude of the vibrations satisfies (e.g., exceeds) a magnitude threshold, then the vibrations may be great enough to damage the target object(s) after a given length of time, and, thus, the computer 102 may proceed with generating the one or more candidate additive manufacturing vibration damping object models. In some examples, the vibration parameter threshold may be preconfigured. For example, the vibration parameter threshold may represent a predefined vibration norm for a given structure or type of the target object(s). In other examples, the vibration parameter threshold may be dynamic. For example, the computer 102 may identify the vibration parameter threshold based on changes in health status in the target object(s), a level of connectivity of the target object(s) to the vibration source, a material of the target object(s), or the like. In some examples, the computer 102 may determine whether or not the vibration parameter exceeds the vibration parameter threshold by performing a digital twin simulation of the vibrations on the target object(s). The digital twin simulation may be a virtual replica of the area of the target object(s), and may model vibrations of the target object(s). Additionally, or alternatively, the computer 102 may identify the vibration parameter threshold by performing the digital twin simulation of the vibrations on the target object(s) (e.g., based on a current health condition of the target object(s)).

In some aspects, the computer 102 may generate the one or more candidate additive manufacturing vibration damping object models based on data associated with additive manufacturing vibration damping objects. The additive manufacturing vibration damping objects may be modeled by the one or more candidate additive manufacturing vibration damping object models. Examples of additive manufacturing vibration damping objects may include active dampers, semi-active dampers, tuned mass dampers, or the like. The data may be associated with the additive manufacturing vibration damping objects in that the data may indicate one or more properties of the additive manufacturing vibration damping objects. For example, the data may include an indication of a type of an additive manufacturing vibration damping object, a shape of the additive manufacturing vibration damping object, dimensions of the additive manufacturing vibration damping object, specifications of the additive manufacturing vibration damping object, anchor types of the additive manufacturing vibration damping object, damping characteristics (e.g., damping capabilities, such as damping diminishing rate, spring constant, or the like) of the additive manufacturing vibration damping object, a physical space occupied by the additive manufacturing vibration damping object, materials from which the additive manufacturing vibration damping object can be constructed, or the like. In some examples, the computer 102 may store, or have access to, a library or knowledge corpus that includes the data (e.g., historical data). In some examples, the computer 102 may segment the area of the target object(s) into the one or more candidate additive manufacturing vibration damping object locations and identify whether and/or how various additive manufacturing vibration damping objects having different sizes and dimensions can be accommodated.

In some aspects, the computer 102 may generate the one or more candidate additive manufacturing vibration damping object models based on one or more anchor locations associated with the one or more candidate additive manufacturing vibration damping object locations. The anchor locations may be one or more points where the one or more additive manufacturing vibration damping objects are secured to the target object(s) and/or a vibration source. In some examples, the computer 102 may determine whether a given type of the additive manufacturing vibration damping objects can feasibly connect to the target object(s) at the one or more anchor locations (e.g., whether the area can accommodate (e.g., fit) the additive manufacturing vibration damping objects in view of the anchor locations). In some examples, the computer 102 may evaluate various anchor types, additive manufacturing vibration damping objects, or combinations thereof, which may have different corresponding anchor locations.

As shown by reference number 260, the computer 102 may identify one or more predicted vibration damping rates associated with the one or more candidate additive manufacturing vibration damping object models. A predicted vibration damping rate may be a measure of how rapidly a detected vibration is expected to decay over time. The one or more predicted vibration damping rates may be associated with the one or more candidate additive manufacturing vibration damping object models in that the predicted vibration damping rate may be a measure of how rapidly a detected vibration in the one or more target objects or in a vibration propagation path of the one or more target object(s) is expected to decay over time. The computer 102 may identify the one or more predicted vibration damping rates based on the data associated with the additive manufacturing vibration damping objects, the spatial data, the vibration data, or the like. In some examples, the predicted vibration damping rate may be greater than a target vibration damping rate. For example, the computer 102 may determine that the predicted vibration damping rate(s) would lower a magnitude of the vibrations below the vibration parameter threshold. In such cases, the additive manufacturing apparatus may print the additive manufacturing vibration damping object(s). For example, the computer 102 may transmit the one or more candidate additive manufacturing vibration damping object models to the additive manufacturing apparatus, and/or cause the additive manufacturing apparatus to perform an additive manufacturing process whereby the additive manufacturing vibration damping object(s) is/are created. The additive manufacturing process may involve a sequence of additive manufacturing (e.g., 3D printing) operations, such as nozzle movement, additive manufacturing material extrusion, or the like. Additionally, or alternatively, the computer 102 may generate a plan for the additive manufacturing process (e.g., an indication of the sequence of additive manufacturing operations). In some examples, the additive manufacturing apparatus may create the additive manufacturing vibration damping object(s) in a separate location from the candidate additive manufacturing vibration damping location(s), and the additive manufacturing vibration damping object(s) may be transported to and installed in the candidate additive manufacturing vibration damping location(s). In other examples, the additive manufacturing apparatus may create the additive manufacturing vibration damping object(s) in the candidate additive manufacturing vibration damping location(s). In some examples, the additive manufacturing apparatus may apply an appropriate temperature to the additive manufacturing material (e.g., a filler material, a 3D printing material, or the like) such that a flowability of the additive manufacturing material is maintained. Additionally, or alternatively, the additive manufacturing apparatus may create the additive manufacturing vibration damping object(s) using a given type of filament, one or more curing characteristics (e.g., curing time and/or curing wavelength, which may produce a plastic with a given set of properties), a given resin, or the like. The computer 102 may select one or more of the temperature, filament, curing characteristics, resin, or the like.

In some aspects, the computer 102 may identify the one or more predicted vibration damping rates using a digital twin simulation. The digital twin simulation may model a vibration damping performance of the one or more candidate additive manufacturing vibration damping object models on the target object(s). For example, the computer 102 may use the digital twin simulation, historical data, and/or data associated with additive manufacturing vibration damping objects to identify how effectively the one or more candidate additive manufacturing vibration damping object models would diminish the vibrations (e.g., vibration generation and/or propagation). In some examples, the digital twin simulation may account for the anchor location(s) of the one or more candidate additive manufacturing vibration damping objects. In some examples, the computer 102 may use the predicted vibration damping rates to identify an amount of vibration that would remain in or near the target object(s) if the candidate additive manufacturing vibration damping object(s) were installed. For example, the computer 102 may determine that the predicted vibration damping rate(s) would lower a magnitude of the vibrations below the vibration parameter threshold. In some examples, the computer 102 may perform a series of digital twin simulations to evaluate the one or more predicted vibration damping rates of a plurality of candidate additive manufacturing vibration damping object models. For example, the series of digital twin simulations may evaluate iterations of the candidate additive manufacturing vibration damping object models with adjusted characteristics that change (e.g., increase) the predicted vibration damping rate compared to one or more previously modeled candidate additive manufacturing vibration damping objects. Examples of characteristics that the computer 102 may adjust may include an additive manufacturing material of a candidate additive manufacturing vibration damping object, a spring constant of a candidate additive manufacturing vibration damping object, a shape of a candidate additive manufacturing vibration damping object, dimensions of a candidate additive manufacturing vibration damping object, a functionality of a candidate additive manufacturing vibration damping object, or the like.

In some aspects, the computer 102 may generate, by the device, based on the one or more predicted vibration damping rates, one or more additional candidate additive manufacturing vibration damping object models. For example, the computer 102 may determine that the predicted vibration damping rate(s) of the one or more candidate additive manufacturing vibration damping object models would not lower a magnitude of the vibrations below the vibration parameter threshold. In such cases, the computer 102 may generate the one or more additional candidate additive manufacturing vibration damping object models, which may be further iterations of the one or more candidate additive manufacturing vibration damping object models (e.g., with adjusted sizes, shapes, dimensions, functionality, or the like). For example, the computer 102 may determine that predicted vibration damping rate(s) of the one or more additional candidate additive manufacturing vibration damping object models may lower a magnitude of the vibrations below the vibration parameter threshold. For example, the computer 102 may identify the predicted vibration damping rate(s) using a digital twin simulation, as discussed above. In such cases, the additive manufacturing apparatus may print the additional additive manufacturing vibration damping object(s), as discussed above in connection with printing the additive manufacturing vibration damping object(s).

Generating the one or more candidate additive manufacturing vibration damping object models based on the vibration damping rate and the one or more candidate additive manufacturing vibration damping object locations, and identifying the one or more predicted vibration damping rates associated with the one or more candidate additive manufacturing vibration damping object models, may help to damp vibrations in or near target objects, thereby mitigating structural damage, reducing equipment malfunction, increasing productivity, and improving worker safety. Furthermore, the computer 102 may avoid a trial-and-error approach involving multiple iterations of candidate additive manufacturing vibration damping objects. Thus, consumption of memory and processing resources in electronic tools that would otherwise be used to repeatedly add, remove, and/or re-locate candidate additive manufacturing vibration damping objects may be reduced. Additionally, or alternatively, consumption of memory and processing resources in electronic manufacturing tools that would otherwise manufacture different candidate additive manufacturing vibration damping objects may be reduced. As a result, the computer 102 may reduce excessive or redundant consumption of memory or processing resources.

Generating the one or more candidate additive manufacturing vibration damping object models based on the vibration parameter satisfying the vibration parameter threshold may help to further reduce consumption of memory or processing resources. For example, the computer 102 may avoid generating the one or more candidate additive manufacturing vibration damping object models (which may involve memory or processing resources) in cases where the vibration parameter does not exceed the vibration parameter threshold.

FIGS. 2A-2C are provided as an example. Other examples may differ from what is described with regard to FIGS. 2A-2C.

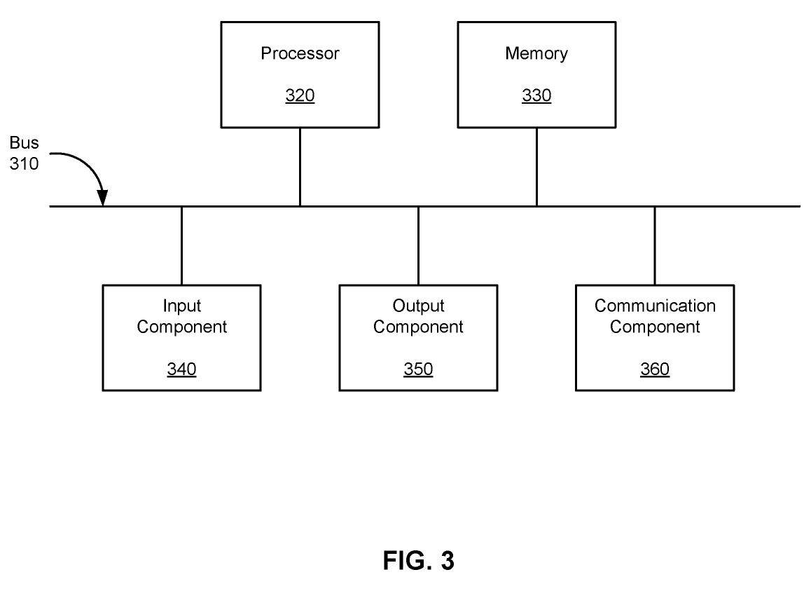

FIG. 3 is a diagram of example components of a device 300 associated with additive manufacturing for vibration damping. The device 300 corresponds to one or more of the computer 102, the EUD 106, the remote server 108, the public cloud 110, and/or the private cloud 112. In some implementations, the computer 102, the EUD 106, the remote server 108, the public cloud 110, and/or the private cloud 112 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as RAM, read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

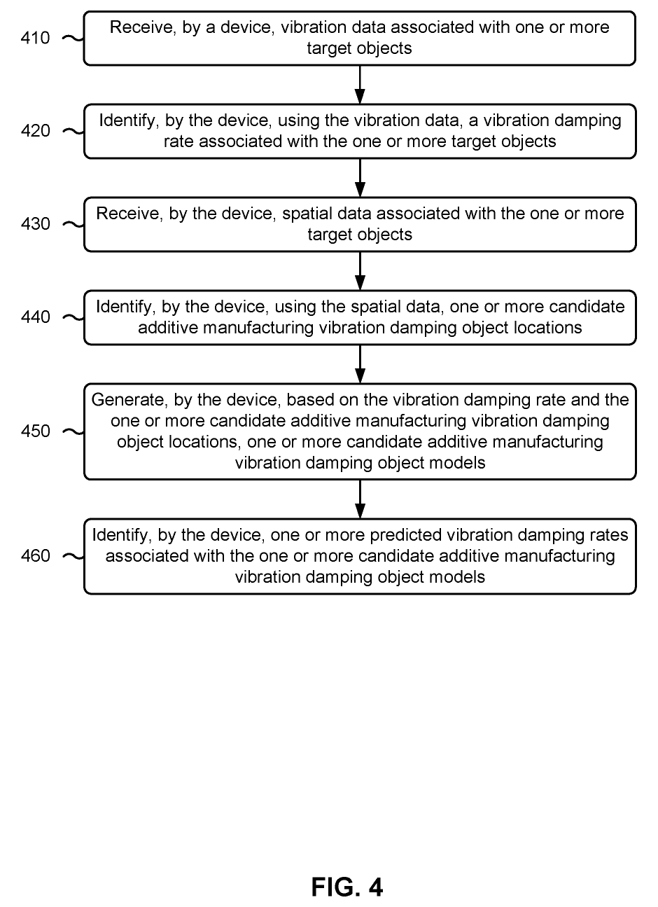

FIG. 4 is a flowchart of an example process 400 associated with additive manufacturing for vibration damping. One or more process blocks of FIG. 4 are performed by a device (e.g., computer 102) and/or by another device or a group of devices separate from or including the device, such as a EUD (e.g., EUD 106), a remote server (e.g., remote server 108), a public cloud (e.g., public cloud 110) and/or a private cloud (e.g., private cloud 112). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving vibration data associated with one or more target objects (block 410). For example, the device may receive vibration data associated with one or more target objects, as described above.

As further shown in FIG. 4, process 400 includes identifying, using the vibration data, a vibration damping rate associated with the one or more target objects (block 420). For example, the device may identify, using the vibration data, a vibration damping rate associated with the one or more target objects, as described above.

As further shown in FIG. 4, process 400 includes receiving spatial data associated with the one or more target objects (block 430). For example, the device may receive spatial data associated with the one or more target objects, as described above.

As further shown in FIG. 4, process 400 includes identifying, using the spatial data, one or more candidate additive manufacturing vibration damping object locations (block 440). For example, the device may identify, using the spatial data, one or more candidate additive manufacturing vibration damping object locations, as described above.

As further shown in FIG. 4, process 400 includes generating, based on the vibration damping rate and the one or more candidate additive manufacturing vibration damping object locations, one or more candidate additive manufacturing vibration damping object models (block 450). For example, the device may generate, based on the vibration damping rate and the one or more candidate additive manufacturing vibration damping object locations, one or more candidate additive manufacturing vibration damping object models, as described above.

As further shown in FIG. 4, process 400 includes identifying one or more predicted vibration damping rates associated with the one or more candidate additive manufacturing vibration damping object models (block 460). For example, the device may identify one or more predicted vibration damping rates associated with the one or more candidate additive manufacturing vibration damping object models, as described above.

Process 400 may include additional aspects, such as any single aspect or any combination of aspects described below and/or in connection with one or more other processes described elsewhere herein.

In a first aspect, identifying the one or more candidate additive manufacturing vibration damping object locations comprises identifying the one or more candidate additive manufacturing vibration damping object locations based on one or more of a vibration source or a vibration propagation path associated with the one or more target objects.

In a second aspect, alone or in combination with the first aspect, generating the one or more candidate additive manufacturing vibration damping object models comprises generating the one or more candidate additive manufacturing vibration damping object models using a generative adversarial network model.

In a third aspect, alone or in combination with one or more of the first and second aspects, generating the one or more candidate additive manufacturing vibration damping object models comprises identifying one or more additive manufacturing materials associated with the one or more candidate additive manufacturing vibration damping object models.

In a fourth aspect, alone or in combination with one or more of the first through third aspects, generating the one or more candidate additive manufacturing vibration damping object models comprises generating the one or more candidate additive manufacturing vibration damping object models based on one or more anchor locations associated with the one or more candidate additive manufacturing vibration damping object locations.

In a fifth aspect, alone or in combination with one or more of the first through fourth aspects, the one or more candidate additive manufacturing vibration damping object models are one or more first candidate additive manufacturing vibration damping object models, and process 400 includes generating, based on the one or more predicted vibration damping rates, one or more second candidate additive manufacturing vibration damping object models.

In a sixth aspect, alone or in combination with one or more of the first through fifth aspects, generating the one or more candidate additive manufacturing vibration damping object models comprises generating the one or more candidate additive manufacturing vibration damping object models based on one or more operational or environmental factors.

In a seventh aspect, alone or in combination with one or more of the first through sixth aspects, generating the one or more candidate additive manufacturing vibration damping object models comprises generating the one or more candidate additive manufacturing vibration damping object models based on an accessibility of an additive manufacturing apparatus, and the accessibility is associated with the one or more candidate additive manufacturing vibration damping object locations.

In an eighth aspect, alone or in combination with one or more of the first through seventh aspects, generating the one or more candidate additive manufacturing vibration damping object models comprises generating the one or more candidate additive manufacturing vibration damping object models based on a vibration parameter associated with the one or more target objects satisfying a vibration parameter threshold.

In a ninth aspect, alone or in combination with one or more of the first through eighth aspects, generating the one or more candidate additive manufacturing vibration damping object models comprises generating the one or more candidate additive manufacturing vibration damping object models based on data associated with additive manufacturing vibration damping objects.

In a tenth aspect, alone or in combination with one or more of the first through ninth aspects, identifying the one or more predicted vibration damping rates comprises identifying the one or more predicted vibration damping rates using a digital twin simulation.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
receiving, by a device, vibration data associated with one or more target objects;
identifying, by the device, using the vibration data, a vibration damping rate associated with the one or more target objects;
receiving, by the device, spatial data associated with the one or more target objects;
identifying, by the device, using the spatial data, one or more candidate additive manufacturing vibration damping object locations;
generating, by the device, based on the vibration damping rate and the one or more candidate additive manufacturing vibration damping object locations, one or more candidate additive manufacturing vibration damping object models; and
identifying, by the device, one or more predicted vibration damping rates associated with the one or more candidate additive manufacturing vibration damping object models.

2. The computer-implemented method of claim 1, wherein identifying the one or more candidate additive manufacturing vibration damping object locations comprises:
identifying the one or more candidate additive manufacturing vibration damping object locations based on one or more of a vibration source or a vibration propagation path associated with the one or more target objects.

3. The computer-implemented method of claim 1, wherein generating the one or more candidate additive manufacturing vibration damping object models comprises:
generating the one or more candidate additive manufacturing vibration damping object models using a generative adversarial network model.

4. The computer-implemented method of claim 1, wherein generating the one or more candidate additive manufacturing vibration damping object models comprises:
identifying one or more additive manufacturing materials associated with the one or more candidate additive manufacturing vibration damping object models.

5. The computer-implemented method of claim 1, wherein generating the one or more candidate additive manufacturing vibration damping object models comprises:
generating the one or more candidate additive manufacturing vibration damping object models based on one or more anchor locations associated with the one or more candidate additive manufacturing vibration damping object locations.

6. The computer-implemented method of claim 1, wherein the one or more candidate additive manufacturing vibration damping object models are one or more first candidate additive manufacturing vibration damping object models, the computer-implemented method further comprising:
generating, by the device, based on the one or more predicted vibration damping rates, one or more second candidate additive manufacturing vibration damping object models.

7. The computer-implemented method of claim 1, wherein generating the one or more candidate additive manufacturing vibration damping object models comprises:
generating the one or more candidate additive manufacturing vibration damping object models based on one or more operational or environmental factors.

8. The computer-implemented method of claim 1, wherein generating the one or more candidate additive manufacturing vibration damping object models comprises:
generating the one or more candidate additive manufacturing vibration damping object models based on an accessibility of an additive manufacturing apparatus, wherein the accessibility is associated with the one or more candidate additive manufacturing vibration damping object locations.

9. The computer-implemented method of claim 1, wherein generating the one or more candidate additive manufacturing vibration damping object models comprises:
generating the one or more candidate additive manufacturing vibration damping object models based on a vibration parameter associated with the one or more target objects satisfying a vibration parameter threshold.

10. The computer-implemented method of claim 1, wherein generating the one or more candidate additive manufacturing vibration damping object models comprises:
generating the one or more candidate additive manufacturing vibration damping object models based on data associated with additive manufacturing vibration damping objects.

11. The computer-implemented method of claim 1, wherein identifying the one or more predicted vibration damping rates comprises:
identifying the one or more predicted vibration damping rates using a digital twin simulation.

12. A computer system comprising:
a processor set;
one or more computer-readable storage media; and
program instructions stored on the one or more computer-readable storage media to cause the processor set to perform operations comprising:
receiving vibration data associated with one or more target objects;
identifying, using the vibration data, a vibration damping rate associated with the one or more target objects;
receiving spatial data associated with the one or more target objects;
identifying, using the spatial data, one or more candidate additive manufacturing vibration damping object locations;
generating, based on the vibration damping rate and the one or more candidate additive manufacturing vibration damping object locations, one or more candidate additive manufacturing vibration damping object models using a generative adversarial network model; and
identifying one or more predicted vibration damping rates associated with the one or more candidate additive manufacturing vibration damping object models.

13. The computer system of claim 12, wherein identifying the one or more candidate additive manufacturing vibration damping object locations comprises:
identifying the one or more candidate additive manufacturing vibration damping object locations based on one or more of a vibration source or a vibration propagation path associated with the one or more target objects.

14. The computer system of claim 12, wherein generating the one or more candidate additive manufacturing vibration damping object models comprises:
identifying one or more additive manufacturing materials associated with the one or more candidate additive manufacturing vibration damping object models.

15. The computer system of claim 12, wherein generating the one or more candidate additive manufacturing vibration damping object models comprises:
generating the one or more candidate additive manufacturing vibration damping object models based on one or more anchor locations associated with the one or more candidate additive manufacturing vibration damping object locations.

16. The computer system of claim 12, wherein generating the one or more candidate additive manufacturing vibration damping object models comprises:
generating the one or more candidate additive manufacturing vibration damping object models based on a vibration parameter associated with the one or more target objects satisfying a vibration parameter threshold.

17. A computer program product comprising:
one or more computer-readable storage media; and
program instructions stored on the one or more computer-readable storage media to perform operations comprising:
receiving vibration data associated with one or more target objects;
identifying, using the vibration data, a vibration damping rate associated with the one or more target objects;
receiving spatial data associated with the one or more target objects;
identifying, using the spatial data, one or more candidate additive manufacturing vibration damping object locations;
generating, based on the vibration damping rate and the one or more candidate additive manufacturing vibration damping object locations, one or more candidate additive manufacturing vibration damping object models; and
identifying one or more predicted vibration damping rates associated with the one or more candidate additive manufacturing vibration damping object models using a digital twin simulation.

18. The computer program product of claim 17, wherein the one or more candidate additive manufacturing vibration damping object models are one or more first candidate additive manufacturing vibration damping object models, and wherein the operations further comprise:
generating, based on the one or more predicted vibration damping rates, one or more second candidate additive manufacturing vibration damping object models.

19. The computer program product of claim 17, wherein generating the one or more candidate additive manufacturing vibration damping object models comprises:
generating the one or more candidate additive manufacturing vibration damping object models based on one or more operational or environmental factors.

20. The computer program product of claim 17, wherein generating the one or more candidate additive manufacturing vibration damping object models comprises:
generating the one or more candidate additive manufacturing vibration damping object models based on an accessibility of an additive manufacturing apparatus, wherein the accessibility is associated with the one or more candidate additive manufacturing vibration damping object locations.
